(19) United States
(12) Patent Application Publication
(10) Pub. No.: US 2006/0031585 A1
(43) Pub. Date: Feb. 9, 2006

(54) Configuration options for a segmented print job

(75) Inventors: Mary Nielsen, Eagle, ID (US); Robert D. Christiansen, Boise, ID (US); Robert E. Stevahn, Boise, ID (US); Paul R. Wissenbach, Boise, ID (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(73) Assignee: Hewlett-Packard Development Company, L.P.

(21) Appl. No.: 10/850,063

(22) Filed: May 20, 2004

(51) Int. Cl. G06F 15/16

(52) U.S. Cl. 709/246

(57) ABSTRACT

Configuration options for a segmented print job are translated into first and second formats for first and second printing systems. A first portion of the segmented print job and the first format for the configuration options may be forwarded to the first printing system. A second portion of the segmented print job and the second format for the configuration options may be forwarded to the second printing system.

### BACKGROUND

Print jobs typically consume three pieces of information in order to properly process on a printing device: raster image processor (RIP) options, printing device specific options, and the print data that is to be rendered to print media. The print data includes layout instructions as well as raster's text or vector data to be printed. A RIP is hardware, software, and/or firmware that converts pages described as a mixture of raster images, text, and vector graphics statements into raster graphic images or bitmaps which are understood by a specific printing device. A RIP directly communicates with one or more printing devices. Moreover, a single networked environment can include a variety of RIPs. RIP options describe how to rasterize colors for a particular print job, how to draw a graphical shape, and the like. Device specific options identify how a specific printing device generates dots, lines, or a page of color (black, grayscale, or multicolor) on print media for output.

Print jobs are dynamically managed over a network with one of three approaches. In a first approach, a specific printing device is identified for a print job before that print job is created. In a second approach each local printing system is statically configured for all potential print jobs in that local printing system's print job queue. Finally, in a third approach, a job ticket is used for defining a generic printing system and a generic printing device.

### BRIEF DESCRIPTION OF THE DRAWINGS

FIG. 1 is a flowchart of a method for managing a print job for printing systems, according to an example embodiment.

FIG. 2 is a flowchart of another method for managing print jobs for printing systems, according to an example embodiment.

FIG. 3 is a diagram of a printing configuration system, according to an example embodiment.

FIG. 4 is a flowchart associated with the processing of instructions that manage print jobs for printing systems, according to an example embodiment.

### DETAILED DESCRIPTION

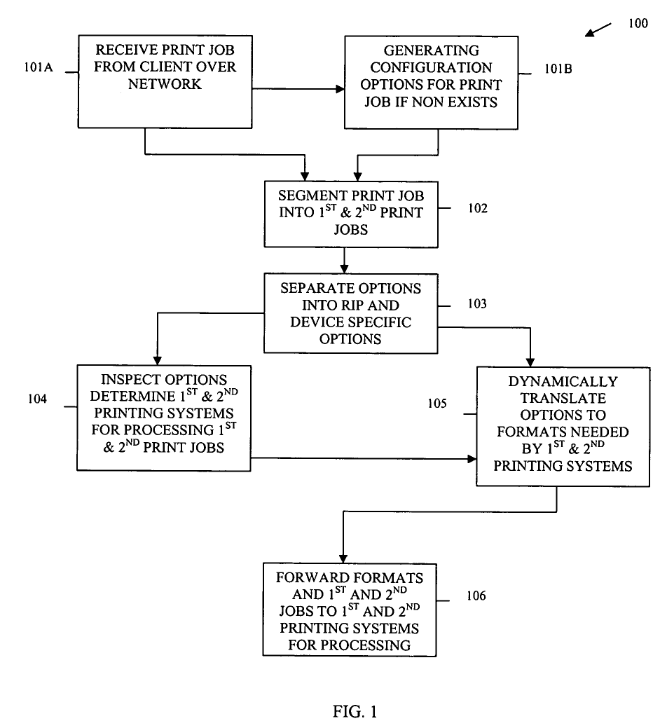

FIG. 1 is a flowchart for one method 100 to manage a print job for printing systems. In one embodiment, a print job may be segmented into multiple print jobs, with printing options translated to provide consistent print results from multiple printers that are used to print the job. The method 100 is implemented in a machine-readable or accessible medium. In one embodiment, the method 100 (hereinafter “processing”) represents a centralized printing service that manages print jobs for a network. The network can be hardwired, wireless, or a combination of hardwired and wireless. Clients process applications for submitting print jobs to the processing, and the processing manages the print jobs in the following novel manners.

A printing system has access to specific processing devices, drivers, RIPs, and the like. A print driver is software, firmware, or hardware that translates data from a software application into a print language, such as Portable Document Format (PDF) or Postscript. A printing device is a device that outputs images, text, and/or graphics to print media. A single printing system can communicate with a plurality of printing devices, and a single printing device may be associated with more than one printing system.

Initially, a client processes an application to create a document and issues a request to process a print job to print media via a printing device. The processing, receives the print job request at 101A. In some embodiments, the print job may not be associated with any particular printing or configuration options. In these embodiments, at 101B, the processing generates a set of configuration options, at 101B, which is consumed by one or more printing systems and printing devices to render that print job to print media. In other embodiments, when the client issues the print job request, the request includes configuration options for that print job.

At 102, the originally received print job is segmented into first and second print jobs. The determination as to whether to segment the print job can be achieved in a variety of manners. For example, it may be that the processing detects an option associated with the print job that requests that it be split into two separate jobs. Alternatively, the processing or another application that cooperates with the processing can determine that based on the size of the print job and/or based on existing processing loads of printing systems and devices that process those printing systems that a particular print job should be segmented into two separate print jobs. In still other embodiments, a user associated with the print job could provide a manual command after the print job is submitted to the processing but before it is processed (e.g., waiting in a print queue for processing) indicating that the user now desires that the print job be segmented. In yet another embodiment, an administrator of the processing could inject a manual command while the print job is in a processing queue indicating that it should be segmented into two sub-print jobs.

Further, the precise segmentation of the print job is configurable, such that the processing can segment the print job into two equal first and second print jobs. Equal in a sense that each job is processing the same amount of pages. Alternatively, the segmentation can be unequal, such that the processing can segment the print job in order for one print job to process a larger share of the pages. Typically, the segmentation occurs on page boundaries of the print job. Although, in some instances, segmentation can also occur for region locations of pages, strips of data on pages, and/or selected or identified elements of data on pages. This means that each sub-print job is processing a different output page associated with the original print job.

At 103, the processing separates the provided print job options into Raster Image Processor (RIP) options and device specific options. This separation permits the processing to more precisely translate the original print job options into formats desired by specific printing systems that independently process the first and second print jobs. The processing maintains mappings or translations between various printing systems and printing devices interfaced to those printing systems. This means that the processing knows if a first printing system renders fonts, graphics, colors, etc. differently from a second printing system and knows how to instruct that second printing system to render information in a consistent manner with the first printing system.

In some embodiments, at 104, the processing inspects the separated RIP and device specific options associated with the original received print job in order to identify first and second printing systems, which are compatible with one another for the options associated with the print job. Compatible means that the processing has a mapping between print options that can produce consistent print media results between the first and second printing systems and their respective printing devices. In some cases, a particular print job may include options that can produce consistent print media results on two separate printing systems, while another print job may include options which may not be translated in order to produce consistent results on the same two printing systems.

It should also be noted, that the processing may segment a received print job into more than two sub-print jobs. In fact, the number of potential sub-print jobs is not bounded by any preset limit.

At 105, once the RIP and device specific options are separated out of the original print job options; the print job is segmented into first and second sub-print jobs; and first and second printing systems are identified as compatible with the original print job options, and the options are dynamically translated for at least one of the two printing systems which will process the sub-print jobs. In some cases the original print job options are translated for both of the printing systems. This may occur when the original print job options are originally provided in a generic description which is not specific to any particular printing system or when the processing generates the original print job options, since the original print job did not include print options when submitted to the processing.

In some embodiments, the original separated RIP options are translated into a first format which can be processed by the first printing system for the first sub-print job, and the same RIP options are translated into a second format which can be processed by the second printing system for the second sub-print job. Again, in some cases, it may be that the original separated RIP options are already natively in a first or second format, such that for one of the printing systems no translation has to occur.

In one instance, the original separated device specific options may be used by the processing to identify the compatible printing systems. That is, the processing selects printing systems which are interfaced to the same or compatible printing devices. In these situations, the processing passes the separated device specific options through directly to the first and second printing systems, such that no translation has to occur with the separated device specific options. In other embodiments, the processing may also translate the original separated device specific options for printing devices that are interfaced to the first and second printing systems in a manner similar to what was discussed above with the separated and then translated RIP options.

Some example mappings between first and second printing systems and/or first and second printing devices associated therewith might include:
1. Print on gloss media→print on Sappi Lustro gloss 100# text from paper drawer 3;
2. Finished print is tabloid full bleed→print centered on 12X18 media, add crops, trim to 11X17; and
3. Print 4 color job→use CMYK ink separations with HDI-180 line screen output intent=ISO coated: for HP Indigo Digital Press use “None” CMYK input profile, HP5000Gloss5xp05.icc output profile and exp05 job lut: for a Design Jet use “ISO coated.icc” input CMYK profile and HPPhotoGloss.icc output profile.

The mappings between disparate printing systems and printing devices can be statically maintained or dynamically resolved based on a variety of environmental information associated with the desired printing systems and printing devices. In some embodiments, the mappings include conditional logic that can be evaluated by and direct the actions of the processing. In one embodiment, one or more of the printing systems and/or printing devices are designed to dynamically publish or communicate their options, such that the processing can dynamically acquire them and generate any desired mappings. The mappings permit the processing to translate between generic RIP and printing device options into specific desired RIP and printing device options. Additionally, in some embodiments, the mappings permit the processing to dynamically translate between first specific RIP and printing device options into second or more specific RIP and printing device options.

At 106, the translated formats for the options and the first and second print jobs are forwarded to the first and second printing systems for processing. Each printing system renders their assigned sub-print job into a raster or bitmap format which can be processed to print media by one of its interfaced printing devices. The print media output is consistent between the two separate printing systems and printing devices that process the first and second print jobs.

Moreover, in some embodiments, the first and second printing systems process on separate processing devices over a network. Thus, the first and second print jobs can be processed in parallel or concurrently with one another. This means that the original print job will complete more quickly and the print media results are consistent between the different printing systems and printing devices. In other embodiments, the first and second printing devices are processed on the same processing device. That same processing device may or may not support parallel processing.

The embodiments of the processing permit print (device specific) and RIP options to be analyzed, translated, and sent across a network to multiple printing systems and printing devices along with a segmented print job for processing. The printing results are consistent across the multiple printing systems and printing devices. Moreover, the processing centrally controls and distributes configurations for a plurality of printing systems which are remote from the processing. These configurations are the dynamically translated options associated with print jobs.

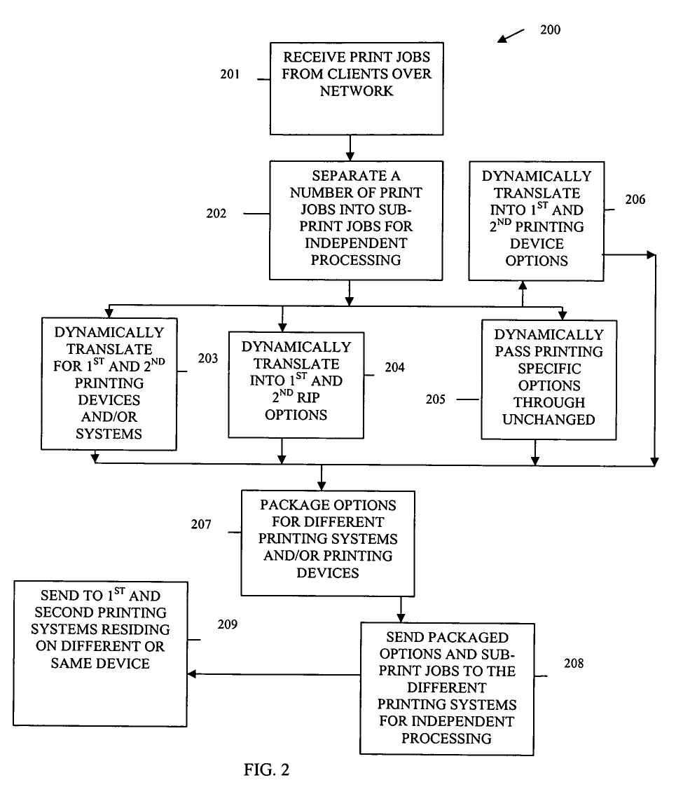

FIG. 2 is a flowchart of another method 200 for managing a print job and printing system configurations over a network. The method is implemented in a machine-accessible or readable medium and is accessible over a network. The network can be hardwired, wireless, or a combination of hardwired and wireless. In one embodiment, the method 200 is implemented as a printing service and is referred to herein and below as a “printing service.” Clients on the network (via applications processing on the clients) make print requests for print jobs via the network to the printing service. The printing service centrally manages, segments, and distributes configuration settings (options) and sub-print jobs (print data) to a plurality of printing systems which are interfaced to printing devices.

Accordingly, at 201, the printing service receives print jobs over the network from one or more applications processing on clients of the network. A number of these received print jobs are separated or segmented, at 202, into sub-print jobs. Each sub-print job is associated with a single segmented print job and is capable of being independently processed by a separate printing system. That processing can occur in parallel with other processing sub-print jobs or can occur at different times from other processing sub-print jobs.

The printing service can determine to separate a number of the received print jobs based on a variety of circumstances. For example, the printing service may determine that a received print job should be segmented because the size of the print data associated with the print job exceeds a predefined threshold, which indicates that the specific print job is segmented or separated into two or more sub-print jobs. Also, the printing service may determine that based on existing processing loads of available printing systems and their devices that no single printing system can adequately and efficiently process an entire specific print job. In this scenario, the printing service determines that the specific print job is best processed by segmenting it into two or more sub-print jobs.

In still other embodiments, a user may have pre-established a specific option with the print job that indicates that the user desires to manually instruct the printing service to segment a specific print job into two or more sub-print jobs. In yet another embodiment, the printing service may segment specific print jobs into sub-print jobs based upon receiving dynamic and manually supplied command overrides from administrators or users. These command overrides can be received dynamically while a specific print job remains in a processing queue for the printing service. In other words, the specific print jobs have not yet been distributed by the printing service to specific printing systems when a dynamic and manually supplied command override instructs the printing service to segment a specific print job into two or more sub-print jobs.

Once a number of the received print jobs are segmented or separated into sub-print jobs, compatible printing systems which can independently service the sub-print jobs are identified. These compatible printing systems produce consistent print media output formats for the sub-print jobs through their respective printing devices. Thus, even though a specific print job is being serviced by different printing systems by way of separate sub-print jobs, the print media output results will be consistent with one another as if the entire specific print job was serviced by a single printing system and single printing device.

Once target or candidate printing systems and devices are identified and selected for servicing the sub-print jobs, a variety of translations may occur on the original print job options in order to ensure proper processing on the different printing systems and devices. These translations are based on static or dynamic mappings which the printing service resolves for the selected printing systems. The mappings when evaluated result in one or more dynamic translations of the original provided print-job options.

For example, the original print job options may include generic RIP options and printing device options. The original print job options can be dynamically translated, at 203, from a generic format to specific formats for specific printing systems and/or specific printing devices. Thus, if the target and different printing systems are first and second printing systems, then the original generic print job options can be dynamically translated into a first format and a second format used by the first and second printing systems, respectively. Alternatively, at 203, the original print job options may already be in a specific format such that they are translated into another specific format which is used by the first and second printing systems or the first and second printing devices.

In some embodiments, at 204, the original print job options are translated in first and second RIP options, where the first RIP options are translated for a first printing system and the second RIP options are translated for a second printing system. In some instances, at 205, the printing specific options used by a specific printing device may have no translation. This means that the original print job included printing device specific options which are compatible with the printing devices that are used to service the sub-print jobs. In these situations, at 205, the printing specific options of the original print job are passed through to the servicing printing devices and printing systems unchanged.

In other embodiments, at 206, each separate printing system which is selected to service one of the sub-print jobs may be interfaced to a different printing device. Thus, the original supplied print job printing specific options are dynamically translated, at 206, into formats that each different printing device can process and still produce consistent print media output between the different printing devices.

In fact, the original print job options can be acquired from an original print job or generated for a received print job. The options can be in an original generic format that is not designed for any specific printing system or printing device or the options can be in an original format that is designed for a specific printing system or printing device. The original format of the options can be segmented into RIP and printing specific options and translated as desired to formats used by servicing printing systems and their interfaced printing devices.

At 207, the dynamic translations of the options are packaged for each of the identified different printing systems and their printing devices, which service the sub-print jobs. The translated formats for the options result in each of the different printing systems and their printing devices rendering consistent print output media for the sub-print jobs. Accordingly, at 208, the packaged options and the sub-print jobs along with their respective print data are sent to the different printing systems that will independently render each of the sub-print jobs. In some embodiments, at 209, the different printing systems are first and second printing systems, which may reside on the same network device or on a different network device from one another.

The printing service maintains or dynamically resolves mappings between RIP options for the different printing systems which it manages and uses these mappings to produce the translations in formats understood by each of the different printing systems. Additionally, the printing service maintains or dynamically resolves mappings between different printing devices which are interfaced to the different printing systems.

Thus, options associated with a specific print job, which is segmented into sub-print jobs, are packaged and distributed to different printing systems for independent processing. The output from the independently processed sub-print jobs can be combined to produce a single consistent print media output which represents the complete processing of a specific segmented print job. In effect, the printing service dynamically configures different printing systems and their printing devices for specific print jobs as desired in order to efficiently process sub-print jobs while ensuring consistent output results for a single segmented print job.

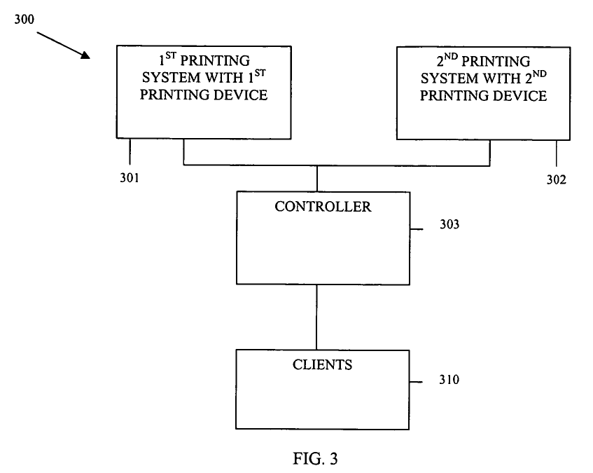

FIG. 3 is a diagram of a printing configuration system 300. The printing configuration system 300 is implemented in a machine-accessible and readable medium and is accessible over a network. The network can be hardwired, wireless, or a combination of hardwired and wireless.

The printing configuration system 300 includes a first printing system 301, a second printing system 302, and a controller 303. In some embodiments, the controller 303 performs the processing described above with respect to methods 100 and 200 of FIGS. 1 and 2, respective. The first and second printing systems 301 and 302 include first and second printing devices, respectively. In some embodiments, the first and second printing devices are the same type of device. In other embodiments, the first and second printing devices are of different types. Moreover, in some instances, the first printing system 301 resides on a different processing device than the second printing device 302. Additionally, in some embodiments, the controller 303 resides on a different processing device than the first and second printing devices 301 and 303. In fact, in some architectural arrangements each of the entities (301-303) of the printing configuration system 300 reside on separate processing devices and are interfaced together via a network with one another.

During operation of the printing configuration system 300, the controller 303 separates print jobs received from networked clients 310 into sub-print jobs. These sub-print jobs can be independently processed and in some instances processed in parallel by the first and second printing systems 301 and 302. The controller 303 decides whether particular print jobs received from clients 310 are to be segmented into sub-print jobs in manners described above with respect to methods 100 and 200 of FIGS. 1 and 2.

Additionally, the controller identifies desired first and second printing systems 301 and 302 based on options associated with a particular received print job or based on specific types of printing devices interfaced and accessible to the first and second printing systems 301 and 302. Again, the techniques for identifying a printing system's (301 or 302) compatibility have been described above with methods 100 and 200 of FIGS. 1 and 2.

Once the controller 303 has segmented a print job into sub-print jobs and identified compatible printing systems 301 and 302, the controller 303 translates the options associated with the segmented print job into formats which the first and second printing systems 301 and 302 can independently process in order to produce consistent print media output results for the sub-print jobs, which are independently processed by the printing systems 301 and 302.

Thus, the controller 303 translates a segmented print job's RIP options into a first format for the first printing system 301 and a second format for the second printing system 302. In some cases, only a single translation is occurs since the original RIP options associated with the original print job may be natively in a first or second format. The first RIP format instructs the first printing system 301 to generate raster or bitmap data for the first printing device for print data associated with a first sub-print job in order to produce an output print media format. The second RIP format instructs the second printing system 302 to generate raster or bitmap data for the second printing device in order to produce the same output print media format. The controller 303 maintains mappings between the first and second printing systems 301 and 302 in order to produce the first and second RIP formats which when processed will instruct the first and second printing systems to produce print results in the same output print media format.

In some embodiments, options originally associated with a segmented print job may also include printer device specific options which are typically not processed by the printing systems 301 and 302 but are passed directly through to the printing devices which are interfaced to the printing systems 301 and 302. In cases where the devices are compatible and accept the same options, the controller 303 simply passes this portion (printing device specific) of the segmented print job options directly through to each of the printing systems 301 and 302 with no further action.

In other embodiments, the controller 303 maintains or has access to conversion utilities or mappings that permit the controller 303 to translate printing device specific options between different printing devices when printing devices are not the same or similar between the two printing systems 301 and 302. Thus, the controller 303 can translate between RIP options and printing device specific options for different printing systems 301 and 302, which service sub-print jobs of a segmented print job.

In some embodiments, the controller 303 performs and monitors processing loads associated with the printing systems 301 and 302 and their respective devices and determines based on processing loads when it is more efficient to segment a particular print job into a plurality of sub-print jobs. In other embodiments, the controller 303 is interfaced with one or more separate load balancing applications that provide the same capabilities and permit the controller 303 to make a segmentation decision.

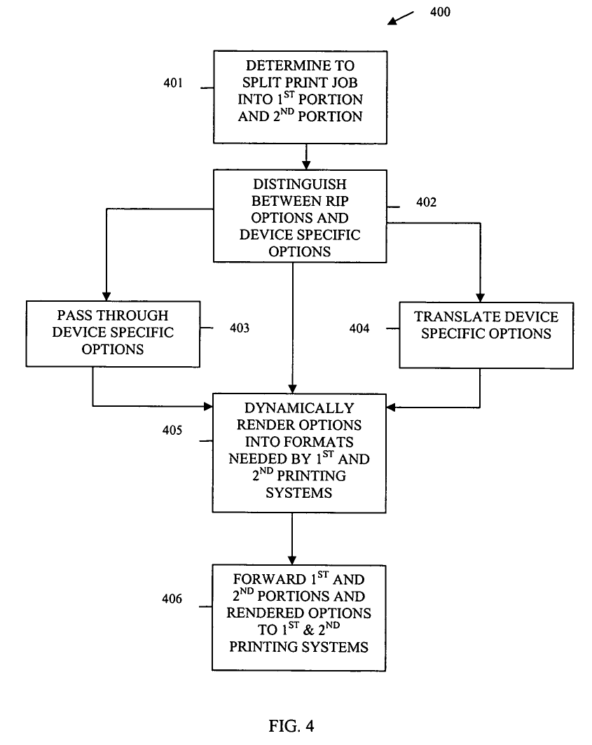

FIG. 4 is a flowchart of still another method 400 for remotely and dynamically managing print jobs and for configuring printing systems over a network. The instructions for processing the method 400 reside on a machine-accessible and readable medium and when loaded and processed on a machine perform the method 400 depicted in FIG. 4. The medium which includes the instructions can be a removable medium or a fixed medium interfaced to a machine. Once installed and processed on a machine, the method 400 is accessible over a network having clients and multiple printing systems, each printing system having one or more interfaced printing devices for producing print results on print media.

At 401, the instructions determine that a received print job (received from a network client) should be split into a first portion and second portion, where each portion can be processed independently to satisfy the originally received print job. In some embodiment, the original print job is received without any options (RIP or printer specific). In these embodiments, the instructions generate generic RIP and printer specific options for the received print job. In other embodiments, the print job is received with both RIP and printer specific options.

At 402, the received print job options are separated into RIP and printer specific options, such that these two types of typical print job options are discemable and distinguished for further processing by the instructions. At this point in the processing, the instructions have enough information to select two different first and second printing systems for servicing the first portion of the print job and the second portion of the print job. This determination can be based on the types of printing devices interfaced to the printing systems and the printer specific options or this determination can be based on the RIP print job options.

If the first printing system is using a same or similar printing device, then, at 403, the instructions will elect to pass through the original received printer specific options associated with the print job to both the first and second printing systems. If the first printing system is using a different printing device, then, at 404, the instructions may translate the original received printer specific options into one or more formats for the first and second printing systems. The formats will cause consistent print results (output's visual appearance) with both the first and second printing devices interfaced to the first and second printing systems.

At 405, the instructions dynamically render the original RIP options associated with the print job into formats desired by the first and second printing systems. Again, these formats will produce consistent output results for the first portion of the print job being processed by the first printing system and the second portion of the print job being processed by the second printing system.

Once the original received print job options are packaged and translated in order to produce consistent output results for the first and second printing systems, the translated options, the first portion of the print job, and the second portion of the print job are forwarded directly to the first and second printing systems, respectively, for processing at 406.

Each of the printing systems will then independently process their respective portions of the originally received print job. This dual processing can occur on different processing devices or on the same processing device. Additionally, the dual processing can occur concurrently or in parallel. Moreover, in one embodiment, the instructions process on a different processing device than the printing systems.

The techniques described herein and above demonstrate how a centralized printing service or technique can be used for dynamically and centrally managing print jobs and configuring printing systems and printing devices in order to maintain consistent print media output results.

The above description is illustrative, and not restrictive. Many other embodiments will be apparent to those of skill in the art upon reviewing the above description. The scope of embodiments should therefore be determined with reference to the appended claims, along with the full scope of equivalents to which such claims are entitled.

The Abstract is provided to comply with 37 C.F.R. §1.72(b) and will allow the reader to quickly ascertain the nature and gist of the technical disclosure. It is submitted with the understanding that it will not be used to interpret or limit the scope or meaning of the claims.

In the foregoing description of the embodiments, various features are grouped together in a single embodiment for the purpose of streamlining the disclosure. This method of disclosure is not to be interpreted as reflecting that the claimed embodiments have more features than are expressly recited in each claim. Rather, as the following claims reflect, inventive subject mater lies in less than all features of a single disclosed embodiment. Thus the following claims are hereby incorporated into the Description of the Embodiments, with each claim standing on its own as a separate exemplary embodiment.

1. A method comprising:
translating configuration options for a segmented print job into a first format for a first printing system and a second format for a second printing system; and
forwarding the first and second formats and first and second portions of the segmented print job to the first and second printing systems, respectively.

2. The method of claim 1 further comprising, receiving the print job from a client over a network.

3. The method of claim 1 further comprising, separating the configuration options into device specific printer options and raster image processor options.

4. The method of claim 1 further comprising, inspecting the configuration options to determine the first and second printing systems which are compatible with processing the print job.

5. The method of claim 1 wherein forwarding includes, sending the first and second formats and the first and second portions to the first and second printing systems that reside on different processing devices within a network.

6. The method of claim 1 wherein forwarding includes, sending the first and second formats and the first and second portions to the first and second printing systems that reside on a same processing device.

7. The method of claim 1 further comprising, generating the configuration options for the print job if the configuration options are not provided with the print job.

8. A method comprising:
receiving print jobs from clients over a network;
separating a number of the print jobs into sub-print jobs, which can be independently processed by different printing systems;
packaging options for the sub-print jobs which are specific to each of the different printing systems and which when processed by the different printing systems produce consistent output formats for the sub-print jobs; and
sending the packaged options and the sub-print jobs to the different printing systems over the network for independent processing.

9. The method of claim 8 further comprising, dynamically translating a portion of the options into first and second printing device options, wherein the first device options are used by a first printing device of a first printing system and the second device options are used by a second printing device of a second printing system, and wherein the first and second printing systems are the different printing systems.

10. The method of claim 8 further comprising, dynamically translating a portion of the options into first Raster Image Processor (RIP) and second RIP options, wherein the first RIP options are used by a first printing system and the second RIP options are used by a second printing system, and wherein the first and second printing systems are the different printing systems.

11. The method of claim 10 further comprising, dynamically passing a second portion of the options through to the first and second printing systems, wherein the second portion are device specific options used by a first printing device of the first printing system and a second printing device of the second printing system.

12. The method of claim 10 further comprising, dynamically translating a second portion of the options into first device options and second device options, wherein the first device options are used by a first printing device of the first printing system and the second device options are used by a second printing device of the second printing system.

13. The method of claim 8, wherein sending further includes sending a first portion of the options to a first printing system residing on a first device and having a first printing device interfaced thereto and sending a second portion of the options to a second printing system residing on a second device and having a second printing device interfaced thereto, and wherein the first and second printing systems are the different printing systems.

14. The method of claim 8, wherein sending further includes sending a first portion of the options to a first printing system residing on a device and sending a second portion of the options to a second printing system residing on the same device, and wherein the first and second printing systems are the different printing systems.

15. A method, comprising:
identifying printing systems capable of producing consistent output results between individual print jobs; and
generating configuration options for each of the individual print jobs, wherein the configuration options are processed by the printing systems with the individual print jobs in order to produce the consistent output results between the printing systems.

16. The method of claim 15, wherein identifying further includes identifying printing devices associated with the printing systems capable of producing the consistent output results.

17. The method of claim 16, wherein generating further includes separating the configuration options into raster image processor options and printing device specific options.

18. The method of claim 15, wherein generating further includes translating selective portions of original configuration options associated with an original print job into formats recognized by the printing systems, wherein the individual print jobs combine to form the original print job.

19. The method of claim 18 further comprising, maintaining as unchanged other portions of the original configuration options and forwarding these unchanged portions to the printing systems.

20. A system, comprising:
a first printing system having a first printing device;
a second printing system having a second printing device; and
a controller which separates print jobs into sub-print jobs for independent processing by the first and second printing systems, wherein the controller dynamically translates raster image processor options for the print jobs into formats that produce consistent output formats on both the first and second printing devices when the options are rendered by the first and second printing systems.

21. The system of claim 20, wherein the controller performs load balancing between the first and second printing systems.

22. The system of claim 20, wherein the controller resides on a different device than the first and second printing systems.

23. The system of claim 22, wherein the first and second printing systems reside on separate devices.

24. The system of claim 20, wherein the controller passes through options to the first and second printing systems which are associated with device specific options of the first and second printing devices if the devices are of a same type.

25. The system of claim 20, wherein the controller translates first printing device specific options into second printing device specific options understood by the second printing device for a number of the sub-print jobs if the first and second printing devices are not of a same type.

26. A computer readable medium for managing print jobs having instructions thereon, the instructions when accessed performing the method comprising:
determining to split a received print job into a first portion and a second portion;
dynamically rendering options for the print job into formats that produce consistent output for a first printing system and a second printing system; and
forwarding the first portion and second portion along with the rendered options to the first printing system and the second printing system for processing.

27. The medium of claim 26 further including instructions for distinguishing between raster image processor options and device specific options that are associated with the options of the print job.

28. The medium of claim 27 further including instructions for passing through the device specific options unchanged to the first and second printing systems.

29. The medium of claim 27, further including instructions for translating the device specific options into a first printing device format used by the first printing system and a second printing device format used by the second printing system.

30. The medium of claim 26, wherein the instructions are processed on a different device than the first and second printing systems and interfaced over a network to the first and second printing systems.
